(19) United States
(12) Patent Application Publication
(10) Pub. No.: US 2006/0188428 A1
(43) Pub. Date: Aug. 24, 2006

(54) Additive for plastic and plastic

(76) Inventors: Kazuo Wakabayashi, Tottori (JP); Takemi Atarashi, Tottori (JP); Arata Miyagi, Tottori (JP); Itsuki Harada, Tottori (JP); Yasuyuki Akamatsu, Tottori (JP); Masakatsu Hiraoka, Shiga (JP); Yoshinobu Yoshihara, Shiga (JP); Shuhei Miyauchi, Osaka (JP); Taizou Imoto, Osaka (JP)

Correspondence Address: OSTROLENK FABER GERB & SOFFEN, 1180 AVENUE OF THE AMERICAS, NEW YORK, NY, 100368403, US

(21) Appl. No.: 10/565,038

(22) PCT Filed: Jul. 14, 2004
(86) PCT No.: PCT/JP04/10385

§ 371 Date: Apr. 26, 2006

(30) Foreign Application Priority Data
Jul. 18, 2003 (JP) 2003199528

(51) Int. Cl. C01F 11/18; C01F 5/14

(52) U.S. Cl. 423/430; 423/635; 524/425; 524/436

(57) ABSTRACT

Disclosed is an additive for a plastic, comprising fine particles obtained by calcination and slaking of a dolomite which exhibits two endothermic peaks in the differential thermal analysis, said fine particles containing calcium carbonate, magnesium carbonate, magnesium oxide, calcium hydroxide and magnesium hydroxide as main chemical components and also containing an ignition loss component in an amount of 10 to 40% by weight based on the weight of said fine particles. A plastic hating hydrogen chloride scavenging properties and antimicrobial properties imparted by incorporating the additive for a plastic is also disclosed.

### TECHNICAL FIELD

The first present invention relates to an additive for a plastic, comprising multicomponent fine particles obtained by calcination and slaking of a dolomite.

The second present invention relates to a plastic containing the additive for a plastic according to the first present invention.

### BACKGROUND ART

It is known that calcium carbonate, calcium silicate, calcium aluminate, calcium hydroxide (slaked lime), magnesium carbonate, magnesium hydroxide, magnesium oxide, aluminum hydroxide, lithium hydroxide, lithium carbonate and sodium carbonate are not suited for practical use as a hydrogen chloride scavenger because they exhibit low scavenging efficiency to hydrogen chloride generated during combustion of polyvinyl chloride and are decomposed at about 800° C. (refer to Patent Document 1).

Patent Document 1: Paragraph Number 0002 of Japanese Unexamined Patent Publication (Kokai) No. 11-193336

There are made a proposal in which dispersibility in polyvinyl chloride is improved by grinding calcium carbonate into fine particles having an average particle size of 1.31 μm or less and a BET specific surface area of 1.7 m²/g or more, thereby to improve hydrogen chloride scavenging properties due to a large amount of calcium carbonate to be incorporated (refer to Patent Document 2), and a proposal in which hydrogen chloride scavenging properties are improved by forming calcium carbonate into cubes having an average particle size of 0.2 μm or less (refer to Patent Document 3).

Patent Document 2: Japanese Unexamined Patent Publication (Kokai) No. 64-9259

Patent Document 3: Paragraph Number 0006 of Japanese Unexamined Patent Publication (Kokai) No. 2002-167486

There is made a proposal in which, since calcium carbonate having low reactivity with hydrogen chloride has its limit in hydrogen chloride scavenging ability, hydrogen chloride scavenging ability are improved by forming calcium hydroxide (slaked lime) into a solid solution with metal such as Mg, Mn, Fe, Co, Ni, Cu or Zn (refer to Paragraph Number 0008 of Patent Document 1).

A method of imparting antimicrobial properties by adding a large amount of calcium hydroxide to a plastic is proposed (refer to Paragraph Number 0005 of Japanese Unexamined Patent Publication (Kokai) No.2000-302615 (Patent Document 4)) and, in Examples of Patent Document 4, a combination of 20 parts by weight of calcium hydroxide, 2 parts by weight of calcium oxide (quick lime) and 74 parts by weight of a high-density polyethylene is described as a composition having antimicrobial properties (refer to Paragraph Number 0011 of Patent Document 4).

Patent Document 4: Paragraph Number 0005 of Japanese Unexamined Patent Publication (Kokai) No.2000-302615

It is well known that, even if a ratio of calcium hydroxide to calcium oxide in Examples of Patent Document 4 is the same as that in Examples of Patent Document 4 (that is, 10 parts by weight (calcium hydroxide)/1 part by weight (calcium oxide)), the resulting composition has poor hydrogen chloride scavenging properties (that is, the composition is not suited for practical use as a hydrogen chloride scavenger).

Also, there are made some proposals in which a dolomite is utilized to scavenge hydrogen chloride generated during refuse firing in an incinerator. However, regarding a dolomite, there are only made a proposal in which a metal oxide, a metal carbonate and a metal hydroxide are used in combination with a dolomite and are used in hydrogen chloride scavenging (refer to Patent Document 5), a proposal in which calcium oxide, zeolite and carbon powder are used in combination with a dolomite and are used in hydrogen chloride scavenging (refer to Patent Document 6), and a proposal in which a dolomite is used as a kind of an alkali substance to be reacted with hydrogen chloride (refer to Patent Document 7).

Patent Document 5: Japanese Unexamined Patent Publication (Kokai) No. 2001-191051

Patent Document 6: Japanese Unexamined Patent Publication (Kokai) No. 7-171323

Patent Document 7: Japanese Unexamined Patent Publication (Kokai) No. 2002-248452

### SUMMARY OF THE INVENTION

Heretofore, there has never existed an idea in which hydrogen chloride scavenging properties and antimicrobial properties are imparted to calcium carbonate, magnesium carbonate, calcium hydroxide, magnesium hydroxide, dolomite and the like, and a study and a disposal about the idea have never been made.

Thus, the present inventors have intensively studied about impartation of hydrogen chloride scavenging properties and antimicrobial properties to those inorganic compounds and minerals and found that it is difficult (substantially impossible) to impart hydrogen chloride scavenging properties and antimicrobial properties depending on the inorganic compounds and minerals alone or a combination thereof.

Also, the present inventors have studied about the inorganic compounds and its coexisting system from a wide point of view including physical chemistry, surface chemistry, reaction theory and the like and found that a product obtained by calcination and slaking of a dolomite allows excellent hydrogen chloride scavenging properties (including dioxins scavenging properties) to appear during incineration of a plastic in the presence of its ignition loss component (that is, high-temperature volatile component) and also imparts antimicrobial properties to the plastic in high efficiency.

An object of the first present invention is to provide an additive for a plastic, which has hydrogen chloride scavenging properties (including dioxins scavenging properties) capable of scavenging hydrogen chloride generated from a incinerated plastic or a peripheral burning material.

Another object of the first present invention is to provide an additive for a plastic, which contains an antimicrobial agent.

Still another object of the first present invention is to provide a hydrogen chloride scavenger to a plastic, and an additive for a plastic, which can be used as an antimicrobial agent.

An object of the second present invention is to provide a plastic having hydrogen chloride scavenging properties (including dioxins scavenging properties) capable of also scavenging a peripheral hydrogen chloride during incineration.

Another object of the second present invention is to provide a plastic which also has antimicrobial properties.

Still another object of the second present invention is to provide a plastic which has both hydrogen chloride scavenging properties and antimicrobial properties.

The additive for a plastic according to the first present invention (present invention described in claim 1) is characterized by comprising fine particles obtained by calcination and slaking of a dolomite which exhibits two endothermic peaks in the differential thermal analysis, and having the following features (A) and (B):
(A) said fine particles containing calcium carbonate, magnesium carbonate, magnesium oxide, calcium hydroxide and magnesium hydroxide as main chemical components and also containing calcium hydroxide in an amount which is more than that of magnesium hydroxide, and
(B) said fine particles containing an ignition loss component in an amount of 10 to 40% by weight based on the weight of said fine particles.

The additive for a plastic according to the second present invention (present invention described in claim 3) is characterized by comprising an additive for a plastic incorporated therein, said additive being defined in the following (I):
(I) an additive for a plastic,
said additive comprising fine particles obtained by calcination and slaking of a dolomite which exhibits two endothermic peaks in the differential thermal analysis, and having the following features (A) and (B):
(A) said fine particles containing calcium carbonate, magnesium carbonate, magnesium oxide, calcium hydroxide and magnesium hydroxide as main chemical components and also containing calcium hydroxide in the amount which is more than that of magnesium hydroxide, and
(B) said fine particles containing an ignition loss component in an amount of 10 to 40% by weight based on the weight of said fine particles.

### BRIEF DESCRIPTION OF THE DRAWINGS

FIG. 1 is a graph showing the results of the differential thermal analysis of main carbonate minerals.

FIG. 2 is a graph showing the results of the differential thermal analysis of dolomites obtained in some diggings in Japan.

### DETAILED DESCRIPTION OF THE INVENTION

[First Present Invention]

The additive for a plastic of the first present invention (the present invention described in claim 1) comprises the above-mentioned specific elements and is in the form of fine particles in which chemical components (plural inorganic compounds) constituting a product obtained by calcination and slaking of a dolomite and an ignition loss component have hydrogen chloride scavenging properties and antimicrobial properties. The present invention described in claim 2 is an invention in which the specific elements of the first present invention are limited.

The first present invention will now be described in detail with respect to a relation with the conditions of a dolomite and fine particles.

<Dolomite>

Fine particles of the first present invention are composed of a product obtained by calcination (thermal decomposition) and slaking (hydration) of a dolomite which exhibits two endothermic peaks in the differential thermal analysis. The dolomite is also a specific name of a mineral containing a double salt of calcium carbonate and magnesium carbonate (CaMg(CO₃)₂) as a chemical component and is also a specific name of a rock made mainly of the mineral (refer to Non-Patent Document 1).

Non-Patent Document 1: “Dolomite” written by Kiyoshi MIYAZAWA, published by Kiyoshi MIYAZAWA, Jun. 25, 1980, addendump 1

The “dolomite” of the present invention is used as a term which means a mineral. Calcium carbonate and magnesium carbonate as chemical components of the dolomite are also contained in a mineral other than the dolomite, for example, calcite, argonite, magnesite, siderite or rhodochrosite.

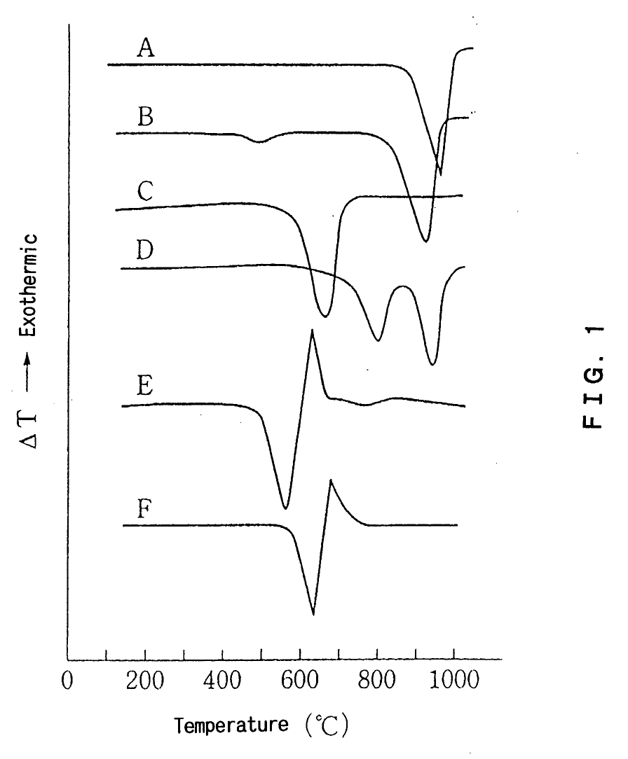

FIG. 1 is a graph showing the results of the differential thermal analysis of main carbonate minerals containing a dolomite (refer to pp. 39 of Non-Patent Document 1. In FIG. 1, the reference symbol A denotes calcite, B denotes argonite, C denotes magnesite, D denotes dolomite, E denotes siderite, and F denotes rhodochrosite.

Calcite, argonite, magnesite, siderite and rhodochrosite as minerals containing chemical components of a dolomite exhibit one endothermic peak in the differential thermal analysis, and siderite and rhodochrosite exhibit an exothermic peak.

It has been found in the present invention that, even if those minerals (that is, minerals showing heat characteristics which are different from those of a double salt of a dolomite) are calcined and slaked, it is difficult (substantially impossible) to form a multicomponent system having hydrogen chloride scavenging properties and antimicrobial properties.

In the present invention, using a dolomite which exhibits two endothermic peaks in the differential thermal analysis as a raw mineral, the dolomite is calcined and slaked to give a product which enjoys the effects of the present invention. A mineral other than the dolomite can be used in the present invention if a quantitative ratio of the double salt of the dolomite is large and the results of the differential thermal analysis are the same as those of the dolomite.

The dolomite is mined in Japan and foreign countries, and a molar ratio of calcium carbonate to magnesium carbonate slightly shifts from 1:1 in case of dolomites obtained in many diggings. In case of 99% of domolites obtained in diggings in Japan, each analytical value of calcium carbonate and magnesium carbonate is within a range from 1.07 to 1.63 expressed in terms of a molar ratio CaO/MgO (refer to pp. 22-26 of Non-Patent Document 1). Also in case of dolomoites obtained in diggings in U.S.A., Canada, Germany, United Kingdom and former Soviet Union, a molar ratio CaO/MgO is within a range from 0.99 to 1.10.

Even if the dolomite is mined in any of Japan and foreign countries, it is possible to obtain fine particles (that is, chemical component as a specific element and an ignition loss component of the present invention), which enjoys the effects of the invention when used in the present invention, by calcination and slaking of a dolomite as far as a molar ratio of a double salt expressed in terms of CaO/MgO is within a general range (specifically, within a range from 0.99 to 1.63).

In case of the most dolomites mined in Japan, an amount of calcium carbonate as a chemical component is from about 31 to 35% by weight expressed in terms of calcium oxide based on a dolomite unit weight and an amount of magnesium carbonate as a chemical component is from about 17 to 20% by weight in terms of magnesium oxide based on a dolomite unit weight expressed, and an amount of an ignition loss component is from about 44 to 47% by weight based on a dolomite unit weight (refer to pp. 15, addendum pp. 2 of Non-Patent Document).

When using a dolomite containing these chemical components and the ignition loss component, fine particles of the present invention can be produced by calcination and slaking of the dolomite.

Regarding a temperature range of two endothermic peaks in the differential thermal analysis of the dolomite, even if difference in diggings of the dolomite and slight shift of the molar ratio of the double salt exist, an endothermic peak in the first stage appears at a temperature within a range from about 730 to 830° C. and an endothermic peak in the second stage appears at a temperature within a range from about 890 to 930° C. (refer to pp. 43 and 16 of Non-Patent Document 1). The dolomite having these temperature ranges of endothermic peaks is converted into a calcine through two-stage thermal decomposition in these endothermic temperature ranges. Regarding thermal decomposition (calcination) of the dolomite, various theories such as carbonate separation theory, solid solution formation theory, oxide formation theory (classified into a solid phase reaction theory and a solid phase/vapor phase reaction theory), direct formation theory and the like are proposed, but the details are not apparent now. The two-stage thermal decomposition is briefly shown below (refer to pp. 2 of Non-Patent Document 1).
CaCO₃·MgCO₃→CaCO₃+MgO+CO₃ first stage
CaCO₃→CaO+CO₃ second stage

The differential thermal analysis of the inorganic matter is generally conducted while heating at 5 to 50° C./min and the same measurement results are obtained if a temperature raising rate is within the above range. Two peaks of the dolomite in the differential thermal analysis can also be measured while heating at 5 to 50° C./min. In the thermal analysis of the inorganic matter, differential scanning calorimetory (DSC) is used sometimes. However, since the differential thermal analysis and the differential scanning thermal analysis are thermal analyses based on the same principle, the temperature range of the endothermic peak is the same.

In the dolomite, a portion or all of Mg ions of a dolomite lattice may be substituted with Fe ions or Mn ions, or a small amount of calcite (chemical component: CaCO₃) may be contained (refer to addendum pp.2 of Non-Patent Document 1). In the present invention, it is possible to use a dolomite in which a portion of Mg ions may be substituted. The dolomite contains, as impurities, silica, alumina, iron carbonate and the like in a small amount. It has been found in the present invention that impurities do not exert an adverse influence on hydrogen chloride scavenging properties and antimicrobial properties of fine particles because the amount of impurities is small.

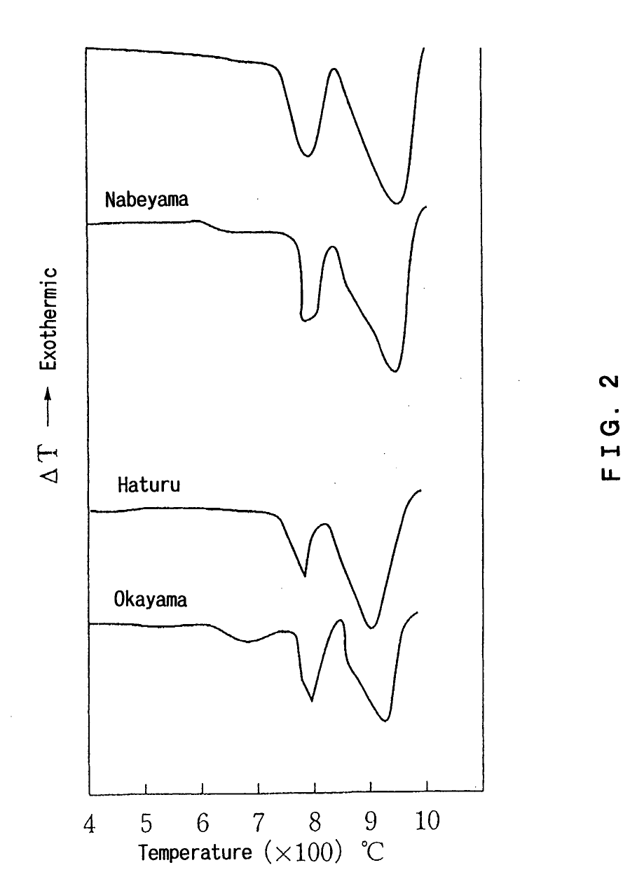

FIG. 2 is a graph showing the results of the differential thermal analysis of dolomites obtained in some diggings in Japan (refer to pp. 42 of Non-Patent Document 1), and dolomites obtained in other diggings show nearly similar results.

<Calcination of Dolomite>

The dolomite is calcined in an air atmosphere or a carbonic acid gas atmosphere. In the carbonic acid gas, the dissociation temperature of calcium carbonate and magnesium carbonate increases. Fine particles of the present invention can be obtained even if the dolomite is calcined in any atmosphere.

In the calcination of the dolomite, contents of a calcine and the state of components (for example, calcium oxide, magnesium oxide) vary depending on the calcination temperature and calcination time. For example, a large influence of a carbonic acid gas generated by thermal decomposition of magnesium carbonate is exerted on calcium oxide, and specific surface area, percentage of voids and hydration reactivity vary depending on the calcination temperature.

In the fields of ceramic industry and construction, the caline of the dolomite is used for various purposes and calcination is conducted at a calcination temperature within a wide range between a low temperature of about 900° C. to 1400° C. or higher.

In the present invention, calcination is conducted by slaking of a dolomite calcine under the conditions where chemical components and an ignition loss component of fine particles of the present invention (preferably, chemical components and an ignition loss component described in claim 2) are produced. When the dolomite is calcined at a calcination temperature of 900 to 1350° C. (preferably, 900 to 1300° C.) and a calcinations time of 8 to 25 hours (preferably, 10 to 20 hours), a calcine capable of easily producing fine particles of the present invention is obtained by slaking.

<Slaking of Dolomite Calcine>

A calcine of a dolomite is slaked under the conditions where a slaking product contains magnesium oxide as a chemical component and contains calcium hydroxide in an amount which is larger than that of magnesium hydroxide, and also an amount of an ignition loss component is from 10 to 40% by weight based on the weight of fine particles. Fine particles of the present invention are obtained by attaining a state where magnesium oxide is contained in a hydration product by utilizing such a phenomenon that the hydration rate of magnesium oxide produced by calcinations of the dolomite is drastically less than that of calcium oxide.

The calcine can be slaked using any of a wet method and a dry method. In case of a wet slaking method, fine particles of the present invention are easily obtained by slaking at a slaking temperature of 53 to 98° C. (preferably, 60 to 95° C.) and a slaking time of 40 to 100 hours (preferably, 45 to 80 hours).

<Chemical Components and Ignition Loss Component of Fine Particle>

Fine particles of the present invention, which contains calcium carbonate, magnesium carbonate, magnesium oxide, calcium hydroxide and magnesium hydroxide, as main chemical components, and an ignition loss component in an amount of 10 to 40% by weight based on the weight of fine particles by calcinations and slaking of a dolomite, and thus the resulting fine particles has hydrogen chloride scavenging properties and antimicrobial properties and impart these characteristics to a plastic.

The “main chemical components” in the present invention mean that fine particles are substantially composed of these chemical components and also means that, even if a small amount of other components are contained, the same effect obtained from the inorganic compound coexisting system constituting main chemical components is exerted. Typical examples of chemical components of fine particles include calcium carbonate, magnesium carbonate, magnesium oxide, calcium hydroxide and magnesium hydroxide. However, it is possible to contain other components (for example, calcium oxide) in the amount which does not impair chemical characteristics derived from the combination thereof.

Chemical components of fine particles are composed of those containing calcium hydroxide and magnesium hydroxide obtained by slaking (hydration) of a calcine, magnesium oxide of an unhydrate of the calcine, and calcium carbonate and magnesium carbonate which constitute a double salt of a dolomite. Calcium carbonate and magnesium carbonate may be contained as an uncalcine of the dolomite, or may be a product obtained by reacting calcium oxide and magnesium oxide with a carbonic acid gas again.

When calcium hydroxide is contained in an amount which is more than that of magnesium hydroxide (for example, 1.5 to 4.5 (calcium hydroxide)/1(magnesium hydroxide) in a weight ratio), the effects of the invention are improved. Each amount of magnesium oxide, calcium carbonate and magnesium carbonate is less than that of magnesium hydroxide.

The ignition loss component of fine particles is contained in an amount of 10 to 40% by weight based on the weight of fine particles, and thus the ignition loss component imparts hydrogen chloride scavenging properties and antimicrobial properties to fine particles in corporation with an inorganic compound coexisting system which constitutes chemical components of fine particles. The ignition loss component is a component which is decomposed and released by ignition (for example, 1,600° C.).

It has been found in the present invention that, regarding chemical components of fine particles, when an amount of a calcium compound is from 30 to 60% by weight expressed in terms of calcium oxide based on the weight of fine particles and an amount of a magnesium compound is from 15 to 40% by weight expressed in terms of magnesium oxide based on the weight of fine particles, hydrogen chloride scavenging properties and antimicrobial properties of fine particles are improved. When each amount of calcium compound and magnesium compound is not within the above range, the synergistic effect of hydrogen chloride scavenging properties and antimicrobial properties of fine particles rapidly decreases.

The total amount of calcium compound and magnesium compound was controlled within a range from 90 to 98% by weight based on the weight of fine particles by the following reason. That is, fine particles contain impurities typified by silica, alumina, iron oxide and the like and about 2 to 10% by weight of moisture.

The sentence that “the total amount is within a range from 90 to 98% by weight based on the weight of fine particles” means that the amount (% by weight) of the calcium compound and the amount (% by weight) of the magnesium compound% by weight are controlled within a range of numerical limitation and thus the total amount of them is within a range from 90 to 98% by weight based on the weight of fine particles. Also, it has been confirmed by the test in the present invention that, even if chemical components of fine particles are obtained by using the same inorganic compounds as a reagent in combination in the same amount, the resulting fine particles can not have both hydrogen chloride scavenging properties and antimicrobial properties.

Fine particles of the present invention can impart antimicrobial properties to a plastic even if a small amount such as 19 parts by weight of fine particles are added to 100 parts by weight of a hydrogen chloride-containing plastic (refer to Example 6). When fine particles are added in an amount of about 70 parts by weight or more based on 100 parts by weight of the plastic, hydrogen chloride scavenging properties and antimicrobial properties can be imparted to the plastic in a practically effective level (refer to Example 2).

Even if the amount of fine particles of the present invention is from 100 to 140 parts by weight (that is, an amount which can maintain intrinsic physical properties of the plastic) based on 100 parts by weight of the hydrogen chloride-containing plastic, high-level hydrogen chloride scavenging properties and antimicrobial properties can be imparted to the plastic (refer to Example 2).

<Physical Characteristics of Physical Fine Particles>

It has been found in the present invention that fine particles of the present invention become fine particles, which have large BET specific surface area and have a specific surface that is effective to hydrogen chloride scavenging and an antimicrobial action (espcially, hydrogen chloride scavenging), through calcinations and slaking of a dolomite.

Also, it has been found in the present invention that, when the resulting particles have a particle size including fine particles having a BET specific surface area of 20 m²/g or more is controlled by entirely or partially utilizing a specific surface area increasing phenomenon through calcination of a dolomite, hydrogen chloride scavenging properties and antimicrobial properties are improved and also it is effective to improve dispersibility and affinity to the plastic.

The phrase “particle size including fine particles having a BET specific surface area of 20 m²/g or more” means that fine particles having a BET specific surface area of 20 m²/g or more exist in fine particles obtained in the state where particles having a fixed particle size are distributed.

Also, it has been found in the present invention that, when the resulting particles are particles having a particle size including fine particles having a BET specific surface area of 20 m²/g or more, dispersibility and affinity to the plastic are improved and, when a thermal decomposition phenomenon of the dolomite is utilized, it is easy to control to the particle size by using means of controlling the conditions of calcination and slaking of fine particles in combination of mechanical means for converting into fine particles.

Fine particles can be used as single particles, single particles and aggregate particles thereof, or aggregate particles by controlling conversion into fine particles.

The upper limit of the BET specific surface area of fine particles is about 40 m²/g and it becomes difficult to control to value more than the upper limit. When the dolomite is formed into fine particles by calcination and slaking, it is easy to include fine particles having a BET specific surface area of 20 m²/g or more even when using a dry method and/or a wet method.

When fine particles are single fine particles, the particle size can be controlled within a range from about 0.1 to 100 μm or about 1 to 300 nm. In any case, the effects of the present invention are enhanced. Even if the particle size of single fine particles is more than 300 nm to 10 μm, the effects of the present invention are enhanced.

“Fine particles” in the present invention are used as a term which means single fine particles, aggregate fine particles or a combination of single fine particles and aggregate fine particles.

When fine particles are subjected to a surface treatment, reaggregation suppression properties and dispersibility can be enhanced by an improvement in affinity with the plastic.

The method for a surface treatment of fine particles may be any of a known method and a novel method. For example, the surface treatment can be conducted by a known method of coating the surface of fine particles with a higher fatty acid, a higher fatty acid metal salt or a surfactant (refer to Paragraph Numbers 0010 and 0011 of Patent Document 1).

<Surface Treatment of Fine Particles>

The surface of fine particles of the present invention can be treated with a higher fatty acid so as to maintain a specific porous surface structure. It is preferable to use, as the higher fatty acid, butyric acid, caproic acid, caprylic acid, pelargonic acid, capric acid, undecanoic acid, lauric acid, myristic acid, palmitic acid, stearic acid, arachic acid, behenic acid, lignoceric acid, cerotic acid, montanoic acid, melissic acid, 1,2-hydroxystearic acid, oleic acid, ricinoleic acid, or tall oil fatty acid.

Fine particles can be subjected to a surface treatment for the purpose of preventing discoloration of the plastic as far as characteristics involved in the effects of the present invention are not imparted.

<Plastic of Interest>

The plastic of interest according to the present invention is not specifically limited and may be any of a synthetic polymer substance and a natural polymer substance. Regarding the polymer substance, the type of a monomer, polymerization method, polymerization degree and molding method are not specifically limited. Therefore, a high polymerization degree polymer and an oligomer are included n view of polymerization degree. The polymer substance may be any of a thermoplastic resin, a thermosetting resin and a rubber and may contain chlorine or not.

The plastic is a solid obtained by artificially forming the polymer substance as a main raw material into a useful shape (refer to “JIS Industrial Term Dictionary 2th edition”, edited by Japanese Standards Association and issued by Japanese Standards Association, 1987, pp. 1381 (Non-Patent Document 3)).

Examples of the thermoplastic resin include polyvinyl chloride-based resin (polyvinyl chloride, polyvinyl chloride copolymer (vinyl chloride-vinylidene chloride copolymer, etc.)), polyethylene-based resin (polyethylene, chlorinated polyethylene, polyethylene copolymer (ethylene-vinyl acetate copolymer, ethylene-vinyl chloride copolymer, ethylene-ethyl acrylate copolymer, etc.)), polypropylene-based resin (polypropylene, chlorinated polypropylene chloride, polypropylene copolymer (propylene-vinyl chloride copolymer)), polyisobutylene, polystyrene-based resin, polyvinylidene chloride, polyvinyl acetate, nylon-based resin (6, 66, 610 nylon, etc.), polyethylene terephthalate, polybutylene terephthalate, and polymethyl methacrylate.

Examples of the thermosetting resin include epoxy resin, unsaturated polyester resin, phenol resin, urea melamine resin, polyurethane resin, silicone resin, polyamide resin, polyacetal resin, and polycarbonate resin.

Examples of the rubber include natural rubber, isoprene rubber, butadiene rubber, styrene-butadiene rubber, butadiene rubber, butyl rubber, chlorinate butyl rubber, ethylene propylene rubber, chloroprene rubber, and acrylnitrile-butadiene rubber.

[Plastic of Second Present Invention]

The second present invention is directed to a plastic having hydrogen chloride scavenging properties (including dioxins suppressing properties) and antimicrobial properties imparted by incorporating the additive for a plastic of the first present invention.

The additive for a plastic can be incorporated in an amount of 1 to 180 parts by weight based on 100 parts by weight of the plastic. The amount of the additive for a plastic can be decided in consideration of maintaining mechanical properties and physical properties of the plastic.

To the plastic, various additives such as coloring materials, ultraviolet inhibitors, antioxidants, stabilizers, plasticizes and the like can be appropriately added. The additive for a plastic can be mixed and kneaded with the plastic using a known apparatus, for example, mixing roll, Bunbury mixer, kneader, Henshel mixer or the like. The plastic containing the additive for a plastic can be formed into a desired shape using a known molding apparatus. As the molding apparatus, for example, there can be used a T-die molding apparatus, an inflation molding apparatus, an extrusion molding apparatus, a compression molding apparatus, a calendar molding apparatus, a blow molding apparatus, an injection molding apparatus and the like.

The shape of the plastic is not specifically limited and the plastic can be formed into any shape for various purposes.

While the present invention will now be described in more detail by way of examples, it should be understood that these are exemplary of the invention and are not to be considered as limiting.

### EXAMPLES

### Example 1

A dolomite mined in Japan was calcined and slaked to obtain an additive for a plastic (hereinafter abbreviated to an additive) as fine particles. The raw dolomite contains calcium carbonate in an amount of 31 to 35% by weight expressed in terms of calcium oxide based on a dolomite unit weight, magnesium carbonate in an amount of 17 to 20% by weight expressed in terms of magnesium oxide based on a dolomite unit weight, and an ignition loss component in an amount of 44 to 47% by weight based on a dolomite unit weight. Regarding an endothermic peak by the differential thermal analysis of the raw dolomite, both of endothermic peaks in the first and second stages were in a general temperature range of an endothermic peak of the dolomite mined in Japan.

Three kinds of an additive a, an additive b and an additive c in the form of fine particles were produced by controlling the conditions of calcination and slaking of the dolomite. The dolomite was calcined at a calcination temperature of 900 to 1300° C. and a calcination time of 10 to 20 hours. The calcine was slaked at a slaking temperature of 60 to 98° C. and a slaking time of 40 to 85 hours by a wet slaking method.

The additive a, the additive b and the additive c in the form of fine particles contained calcium compound in an amount of 45 to 50% by weight expressed in terms of calcium oxide based on a dolomite unit weight, and magnesium carbonate in an amount of 15 to 40% by weight expressed in terms of magnesium oxide based on a dolomite unit weight. As the calcium compound, calcium hydroxide was contained in an amount which is more than that of calcium carbonate. As the magnesium compound, magnesium hydroxide, magnesium oxide and magnesium carbonate were contained in the order of decreasing an amount. Calcium carbonate was contained in an amount which is larger than that of calcium hydroxide.

The additive a, the additive b and the additive c in the form of fine particles contained an ignition loss component in an amount of 20 to 26% by weight based on the weight of fine particles. Impurities were mainly composed of silica, alumina and iron oxide.

The additive a, the additive b and the additive c in the form of fine particles had an average particle size of 2.4 μm and a BET specific surface area of 21.0 m².

### Example 2

A soft polyvinyl chloride resin was prepared by incorporating 73 parts by weight of dioctyl phthalate as a plasticizer and 1.8 parts by weight of a stabilizer in 100 parts by weight of a polyvinyl chloride resin. Samples 2, 3 and 4 were made by adding 70 parts by weight, 100 parts by weight and 140 parts by weight of the additive a prepared in Example 1 in the form of fine particles to 100 parts by weight of the soft polyvinyl chloride resin.

0.5 g of each sample was placed in a tubular electric furnace at a furnace temperature of 350° C. and, after 10 minutes, the furnace temperature was raised to 700° C. and the sample was combusted while maintaining the same temperature for 30 minutes.

A combustion gas discharged from the sample in the tubular electric furnace was transferred into a bubbling bottle through a conduit, where the combustion gas was absorbed into an alkali solution of a 0.2 N sodium hydroxide solution in the bottle. The aqueous alkali solution was neutralized with nitric acid and subjected to sedimentation titration with a solver nitrate, and thus the amount of hydrogen chloride generated from the sample was determined.

The amount of hydrogen chloride contained in the sample was determined by the following equation (1).
Amount of hydrogen chloride contained in the sample=Amount of hydrogen chloride generated+Amount of hydrogen chloride expressed in terms of the amount of hydrogen chloride in ash content (1)

The hydrogen chloride scavenging ratio was determined from the amount of hydrogen chloride and the amount of hydrogen chloride generated obtained in the equation (1) by the following equation (2).
Hydrogen chloride scavenging ratio (%)=(1−Amount of hydrogen chloride generated/Amount of hydrogen chloride contained in sample)×100 (2)

Table 1 shows the hydrogen chloride scavenging ratio (%) of samples 1, 2, 3 and 4.

According to Table 1, regarding hydrogen chloride generated from the soft polyvinyl chloride resin containing the additive a in the form of fine particles incorporated therein (samples 2, 3 and 4), the scavenging ratio increased in high efficiency by increasing the amount of the additive a.

TABLE 1

| | Vinyl | Amount of | Amount of | |
|---|---|---|---|---|
| | chloride | hydrogen | hydrogen | |
| Sample | resin/ | chloride | chloride in ash | Scavenging |
| No. | Additive | generated (mg/g) | content (mg/g) | ratio (%) |
| 1 | 100/0 | 310.3 | 0.1 | |
| 2 | 100/70 | 59.9 | 159.1 | 72.6 |
| 3 | 100/100 | 8.3 | 194.7 | 95.9 |
| 4 | 100/140 | 2.6 | 176.9 | 98.6 |

### Example 3

Using the additive b and the additive c of Example 1 in the form of fine particles, the same test as in Example 2 was conducted. As a result, as the amount of fine particles to be incorporated in a polyvinyl chloride resin increased, a hydrogen chloride scavenging ratio increased and reached 90% or more when the amount is about 100 parts by weight.

### Example 4

Using a high-density polyethylene resin, and 100 parts by weight a high-density polyethylene resin in which 11 parts by weight, 18 parts by weight or 43 parts by weight of the additive a of Example 1 is incorporated, samples were prepared. Each sample was formed into plates as specimens measuring 5 cm×5 cm using a compression molding apparatus.

0.5 ml of a fungus liquid prepared by diluting E. coli (IF3301O) was applied on each specimen and a polyethylene film was closely contacted with the specimen by covering on it. The specimen was stored at room temperature and relative humidity of 90% for more and, after 24 hours, the viable cell count was measured.

According to Table 2 showing the test results, even if 11 parts by weight of the additive a is incorporated in 100 parts by weight of a high-density polyethylene resin, the viable cell count drastically decreased and a decrease in the viable cell count increased by increasing the amount of the additive a.

TABLE 2

| | Viable cell count |
|---|---|
| Amount of additive to be | after 24 hours |
| incorporated | (cells/ml) |
| 0 parts by weight | 3.1 × 10⁶ |
| 11 parts by weight | 2.1 × 10⁴ |
| 18 parts by weight | 5.3 × 10³ |
| 43 parts by weight | <10 |

### Example 5

Using the additive b and the additive c of Example 1 in the form of fine particles, the same test as in Example 4 was conducted. As a result, when the amount of the additives b and c to be incorporated in the high-density polyethylene resin increased, a decrease in the viable cell count increased, similarly.

### Example 6

A soft polyvinyl chloride resin was prepared by incorporating 73 parts by weight of dioctyl phthalate as a placticizer in 100 parts by weight of a polyvinyl chloride resin. 19 Parts by weight of the additive a of Example 1 was incorporated and the mixture was formed into sheets using a roll kneader and specimens measuring 5 cm×5 cm were made. 0.5 ml of a fungus liquid prepared by diluting E. coli (IF3301O) was applied on each specimen and a polyethylene film was closely contacted with the specimen by covering on it. The specimen was stored at room temperature and relative humidity of 90% for more and, after one hour, the viable cell count was measured. According to Table 3 showing the test results, drastic decrease in viable cell count was recognized after one hour.

TABLE 3

| | Viable cell count after one hour |
|---|---|
| Amount of additive | (average of the measurements |
| to be incorporated | of three times) |
| 19 parts by weight | <10 |
| 0 parts by weight | 1.1 × 10⁵ |

### Comparative Example 1

A sample was prepared by incorporating 100 parts by weight of calcium carbonate in 100 parts by weight of the soft polyvinyl chloride resin prepared in Example 2. 0.5 g of the sample was combusted under the same conditions as those in Example 2 and a hydrogen chloride scavenging ratio was determined in the same manner. From Table 4 which shows the test results, the sample showed a drastically low hydrogen chloride scavenging ratio.

TABLE 4

| | | Amount of | | |
|---|---|---|---|---|
| | Vinyl | hydrogen | Amount of | |
| | chloride | chloride | hydrogen | |
| | resin/ | generated | chloride in ash | Scavenging |
| Sample No. | Additive | (mg/g) | content (mg/g) | ratio (%) |
| Calcium | 100/100 | 141.5 | 57.0 | 28.7 |
| carbonate is | | | | |
| incorporated | | | | |

Effects of the Invention

According to the first present invention, effects typified by the following (A) to (G) can be obtained.
(A) An additive for a plastic, which has hydrogen chloride scavenging properties showing a high scavenging ratio, is provided.
(B) An additive for a plastic, which has high-level antimicrobial properties, is provided.
(C) An additive for a plastic, which scavenges hydrogen chloride in high level even if an amount of the additive for a plastic to be incorporated is an amount enough to maintain physical properties of a plastic, is provided.
(D) An additive for a plastic, which imparts high-level antimicrobial properties to a plastic if an amount of the additive for a plastic is an amount enough to impart hydrogen chloride scavenging properties to the plastic, is provided.
(E) An additive for a plastic, which can modify a plastic into an antimicrobial plastic or a plastic having hydrogen chloride scavenging properties and antimicrobial properties, is provided.
(F) An additive for a plastic, which is harmless and is environmentally friendly, is provided.
(G) An additive for a plastic, which can be incorporated in various plastics, is provided.

According to the second present invention, effects typified by the following (a) to (d) can be obtained.
(a) A plastic, which is harmless and is environmentally friendly and also has hydrogen chloride scavenging properties and antimicrobial properties, is provided.
(b) A plastic having excellent properties for scavenging hydrogen chloride generated from the other burning material in a combustion furnace, is provided.
(c) A plastic, which can be used for various antimicrobial purposes due to excellent antimicrobial properties, is provided.
(d) A plastic, which has hydrogen chloride scavenging properties and antimicrobial properties and also maintain moldability, mechanical and physical properties, are provided.

1. An additive for a platic, comprising fine particles obtained by calcination and slaking of a dolomite which exhibits two endothermic peaks in the differential thermal analysis, and having the following features (A) and (B):
(A) said fine particles containing calcium carbonate, magnesium carbonate, magnesium oxide, calcium hydroxide and magnesium hydroxide as main chemical components and also containing calcium hydroxide in an amount which is more than that of magnesium hydroxide, and
(B) said fine particles containing an ignition loss component in an amount of 10 to 40% by weight based on the weight of said fine particles.

2. An additive for a plastic, comprising fine particles obtained by calcination and slaking of a dolomite which exhibits two endothermic peaks in the differential thermal analysis, and having the following features (i) to (v):
(i) said fine particles containing a calcium compound, which contains calcium carbonate and calcium hydroxide as main components, in an amount of 30 to 60% by weight expressed in terms of calcium oxide based on the weight of said fine particles,
(ii) said fine particles containing a magnesium compound, which contains magnesium carbonate, magnesium oxide and magnesium hydroxide as main components, in an amount of 15 to 40% by weight expressed in terms of magnesium oxide based on the weight of said fine particles,
(iii) said fine particles containing calcium hydroxide in an amount which is more than that of magnesium hydroxide,
(iv) said fine particles containing an ignition loss component in an amount of 10 to 40% by weight based on the weight of said fine particles, and
(v) said fine particles containing a calcium compound expressed in terms of calcium oxide, a magnesium compound expressed in terms of magnesium oxide, and an ignition loss component in the total amount of 90 to 98% by weight based on the weight of said fine particles.

3. A plastic comprising an additive for a plastic incorporated therein, said additive being defined in the following (I):
(I) an additive for a plastic,
said additive comprising fine particles obtained by calcination and slaking of a dolomite which exhibits two endothermic peaks in the differential thermal analysis, and having the following features (A) and (B):
(A) said fine particles containing calcium carbonate, magnesium carbonate, magnesium oxide, calcium hydroxide and magnesium hydroxide as main chemical components and also containing calcium hydroxide in the amount which is more than that of magnesium hydroxide, and
(B) said fine particles containing an ignition loss component in an amount of 10 to 40% by weight based on the weight of said fine particles.

4. The additive for a plastic according to claim 1, which has one or more of the following features (1) to (9):
(1) said dolomite comprising a dolomite mined in Japan,
(2) said dolomite exhibiting an endothermic peak in a first stage within a range from 730 to 830° C. and an endothermic peak in a second stage within a range from 890 to 930° C.,
(3) said dolomite containing calcium carbonate in an amount of 31 to 35% by weight expressed in terms of calcium oxide based on a dolomite unit weight, magnesium carbonate in an amount of 17 to 20% by weight expressed in terms of magnesium oxide based on a dolomite unit weight, and an ignition loss component in an amount of 44 to 47% by weight based on a dolomite unit weight,
(4) said dolomite comprising a dolomite contained in a mineral,
(5) said dolomite comprising calcium carbonate and magnesium carbonate in a molar ratio expressed by CaO/MgO within a range from 0.99 to 1.63,
(6) said fine particles having a particle size including fine particles having a BET specific surface area of 20 m²/g or more,
(7) said fine particles comprising single particles and aggregate particles thereof,
(8) said fine particles comprising aggregate particles, and
(9) said fine particles comprising single particles.
